(19) United States
(12) Patent Application Publication
(10) Pub. No.: US 2017/0223941 A1
(43) Pub. Date: Aug. 10, 2017

(54) Mountable Fishing Baitwell

(71) Applicant: Daniel Wesley Cornwell, Atlantic Beach, FL (US)

(72) Inventor: Daniel Wesley Cornwell, Atlantic Beach, FL (US)

(21) Appl. No.: 15/424,648

(22) Filed: Feb. 3, 2017

Related U.S. Application Data
(60) Provisional application No. 62/291,614, filed on Feb. 5, 2016.

(51) Int. Cl. A01K 97/05; B63B 35/26; A01K 63/02; A01K 63/04; A01K 63/06

(52) U.S. Cl. CPC A01K 97/05; A01K 63/042; A01K 63/06; A01K 63/02; B63B 35/26

(57) ABSTRACT

An apparatus is a mountable fishing baitwell. The apparatus allows a user to easily access live bait and properly sustains live bait. The apparatus includes a support structure, a water reservoir, a mounting base, and an aeration unit. The support structure upholds the water reservoir and houses the aeration unit. The water reservoir contains the water and the live bait. The mounting base secures the apparatus onto the bow rail of a boat. The support structure further includes a structure body, a reservoir bed, and a storage compartment. The water reservoir further includes a receptacle and a hand-permeable cover. The hand-permeable cover detachably attaches about an opening of the receptacle, and thereby prevents the live bait from escaping and allows the receptacle to be refilled. The aeration unit distributes oxygen into the water within the receptacle which better sustains the live bait within the receptacle.

The current application claims priority to U.S. provisional application Ser. No. 62/229,614 filed on Feb. 5, 2016.

### FIELD OF THE INVENTION

The present invention generally relates to a mountable fishing baitwell. More specifically, the present invention mounts to the bow rail of a boat and illuminates the housed bait.

### BACKGROUND OF THE INVENTION

A variety of devices are used to hold fishing bait while fishing. For live bait, fishermen use large containers or baitwells. Using live bait is beneficial due to their natural movement which attracts the attention of fish more easily. Because of this, it is common to keep bait in a fresh supply of aerated water. There are typically two baitwells on a boat, one at the stern and one at the front of the console. However, many fisherman do not have baitwells at the front, which makes accessing bait much more arduous as they are forced to move to the stern.

After losing bait to a striking fish, it is important to rebait quickly and recast to the same spot. This increases the fisherman's chances of catching the previously interested fish. When fishing in-shore, in tidal areas, or other locations, it is common to use a trolling motor which is attached to the bow. By moving to the rear of the boat in order to get more bait, the boat may drift off course. As the fisherman moves back to the correct position, the fisherman needs to turn the motor on. The motor causes a lot of noise and may scare away fish.

It is therefore an objective of the present invention to introduce a mountable fishing well. The present invention is a remote bait aeration device that may be vertically attached to the bow rail, allowing easy access to live bait. The fisherman may fish from the bow or bow seat of a boat while using the present invention. As previously mentioned, there is normally a trolling motor attached to the bow. The present invention allows fisherman to remain on the bow or in their seat and rebait their hook without having to leave the bow and, consequently, abandon the trolling motor. The fisherman need not step down off the bow, access the baitwell, use a bait net to pick out live bait such as a shrimp or minnow, return to the bow position, bait the hook, regain course with the trolling motor, and finally recast. The present invention allows a fisherman to simply reach into a water reservoir, rebait his or her hook, and cast without leaving the bow or lose boat position. As boat noise is a more problem when stalking easily spooked fish, the present invention eliminates noises caused by fisherman having to step off the bow, banging around the live well with a bait net, opening and closing hatch covers, dropping bait nets, and having to repower the trolling motor to regain boat position.

### BRIEF DESCRIPTION OF THE DRAWINGS

FIG. 1 is a perspective view of an embodiment of the present invention, wherein the power source is a portable power source and the mount is a platform.

FIG. 2 is an exploded view of an embodiment of the present invention, wherein the power source is a portable power source and the mount is a platform.

FIG. 3 is a top side view of an embodiment of the present invention, wherein the power source is a portable power source and the mount is a platform.

FIG. 4 is a cross-section view of FIG. 3, wherein the power source is a portable power source and the mount is a platform.

FIG. 5 is a perspective view of an embodiment of the present invention, wherein the power source is a power cord and the mount is a platform.

FIG. 6 is a top side view of an embodiment of the present invention, wherein the power source is a portable power cord and the mount is a platform.

FIG. 7 is a cross-section view of FIG. 6, wherein the power source is a portable power cord and the mount is a platform.

FIG. 8 is a perspective view of an embodiment of the present invention, wherein the power source is a portable power source and the mount is a rigid tube.

FIG. 9 is a front side view of an embodiment of the present invention, wherein the power source is a portable power source and the mount is a platform.

### DETAILED DESCRIPTION OF THE INVENTION

All illustrations of the drawings are for the purpose of describing selected versions of the present invention and are not intended to limit the scope of the present invention.

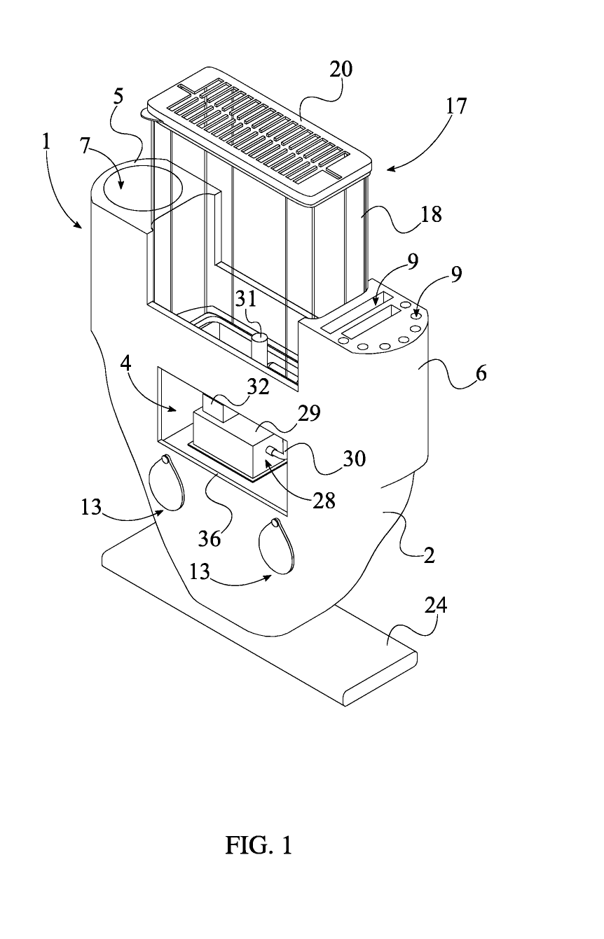

The present invention is a mountable fishing baitwell that allows a user to be near the bait and allows a user to easily retrieve the bait while fishing. The present invention is mountable to the bow rail of a boat so that the user does not have to leave his or her position on the boat in order to retrieve live bait. The present invention facilitates the rebaiting of the user so that the user needs only seconds instead of minutes to rebait. The present invention also houses a variety of other fishing tools such as knives, pliers, fishing hooks, and so on that may be needed throughout fishing. As illustrated in FIG. 1, the present invention comprises a support structure 1, a water reservoir 17, a mounting base 24, and an aeration unit 28. The support structure 1 upholds the water reservoir 17 and houses the aeration unit 28. The slimness of the support structure 1 allows the user to easily maneuver around the present invention while fishing in the bow position. More specifically, the support structure 1 does not extend past the rail of the bow. In order to uphold the water reservoir 17 and house the aeration unit 28, the support structure 1 comprises a structure body 2, a reservoir bed 3, and a storage compartment 4. The structure body 2 is a rigid member that stabilizes and fixes the positions of the water reservoir 17 and aeration unit 28. More specifically, the reservoir bed 3 accommodates the water reservoir 17 within the structure body 2, and the storage compartment 4 allows the aeration unit 28 to be contained within the structure body 2 and be near the water reservoir 17. The water reservoir 17 contains and sustains the live bait, which is properly oxygenated via the aeration unit 28. In addition, the water reservoir 17 comprises a receptacle 18 and a hand-permeable cover 20. The receptacle 18 retains the water and contains the live bait. The hand-permeable cover 20 prevents the live bait from escaping the receptacle 18, while simultaneously allowing the user to retrieve at any point in time. The mounting base 24 fastens and stabilizes the support structure 1 onto the bow rail.

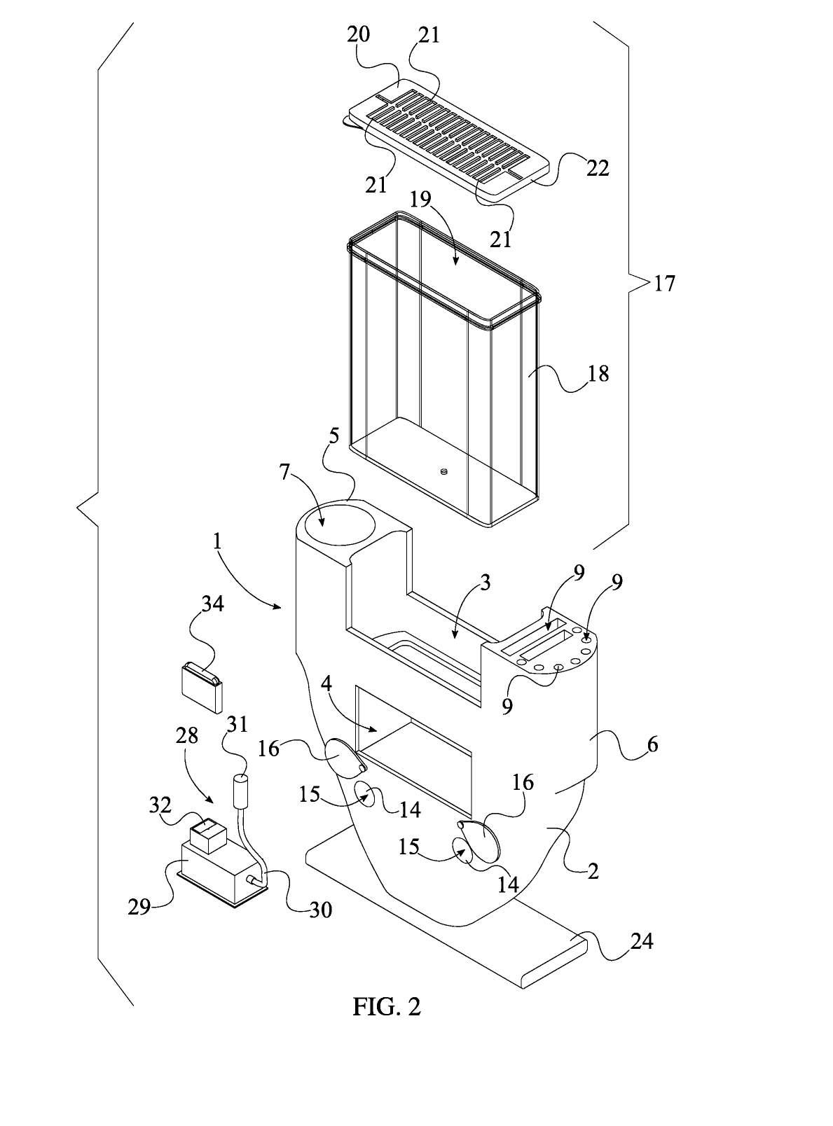

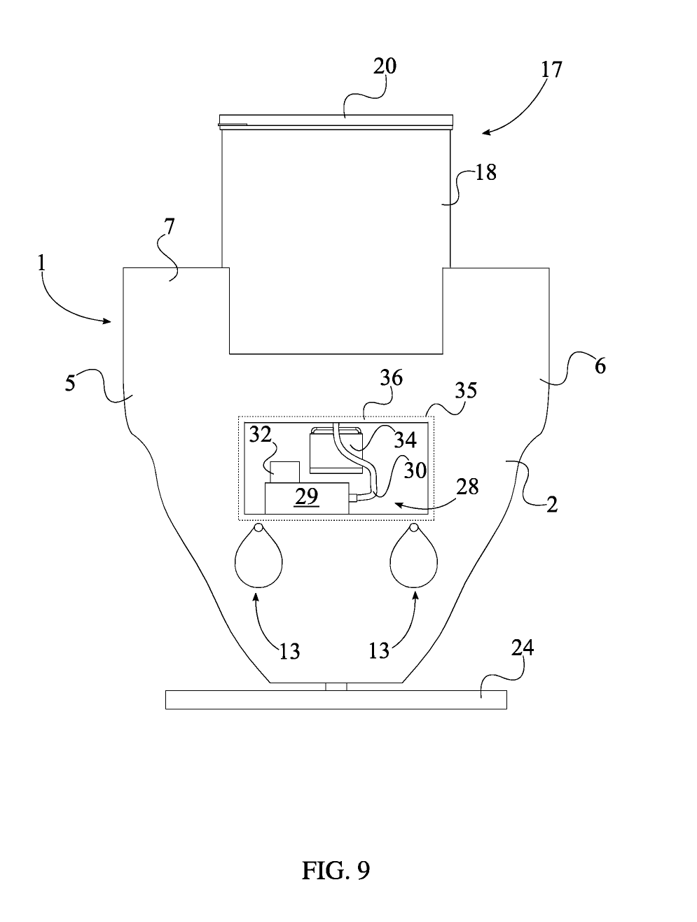

The overall configuration of the aforementioned components allows the present invention to contain and sustain live bait while being easily accessible to the user. In order for the user to access the live bait within the receptacle 18 while the present invention is mounted onto the bow rail of a boat, the mounting base 24 is connected adjacent to the structure body 2, and the reservoir bed 3 is integrated into the structure body 2, opposite to the mounting base 24, as shown in FIG. 2. The storage compartment 4 is integrated into the structure body 2 in between the reservoir bed 3 and the mounting base 24. The integration of the storage compartment 4 within the structure body 2 allows the structure body 2 to uphold the aeration unit 28 and position the aeration unit 28 near the receptacle 18 which is situated within the reservoir bed 3. In the preferred embodiment of the present invention, the structure body 2 further comprises a lip 36. The lip 36 acts as a barrier so that the aeration unit 28 within the storage compartment 4 does not escape throughout travel. The lip 36 traverses along an outer edge 35 of the storage compartment 4, as shown in FIG. 9, in order to prevent the aeration unit 28 and any other stored component from falling out of the structure body 2. The hand-permeable cover 20 is detachably attached about an opening 19 of the receptacle 18 so that the user may refill the water and the live bait within the receptacle 18. The aeration unit 28 is in fluid communication with the receptacle 18 and is mounted within the storage compartment 4 so that the live bait within the receptacle 18 is receives the proper amount of oxygen in order to stay alive.

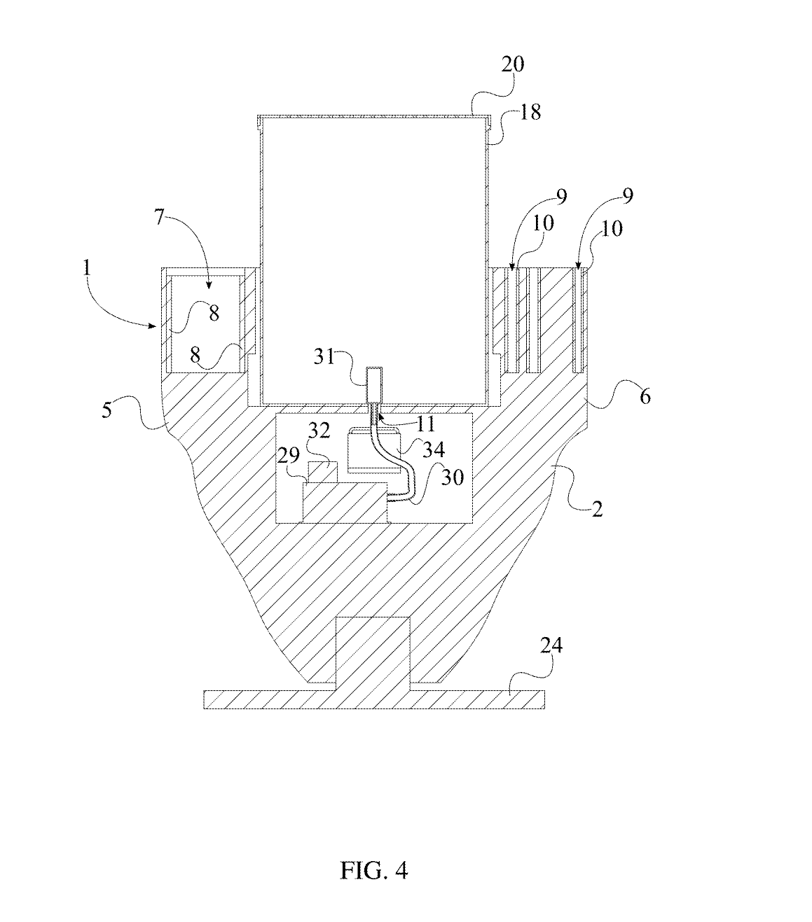

The live bait within the receptacle 18 is visible to the user, even in dark surroundings, because the preferred embodiment of the of the present invention comprises a light source 34. In order for the light source 34 to illuminate the components held within the receptacle 18, both the receptacle 18 and the reservoir bed 3 are made of transparent material, such as glass or clear durable plastic, as illustrated in FIG. 2. The light source 34 is also positioned within the storage compartment 4 and is oriented towards the receptacle 18, as shown in the front view of FIG. 4. Therefore, the light source 34 provides the receptacle 18 with the necessary illumination without being damaged by water within the receptacle 18 or water from the surrounding environment.

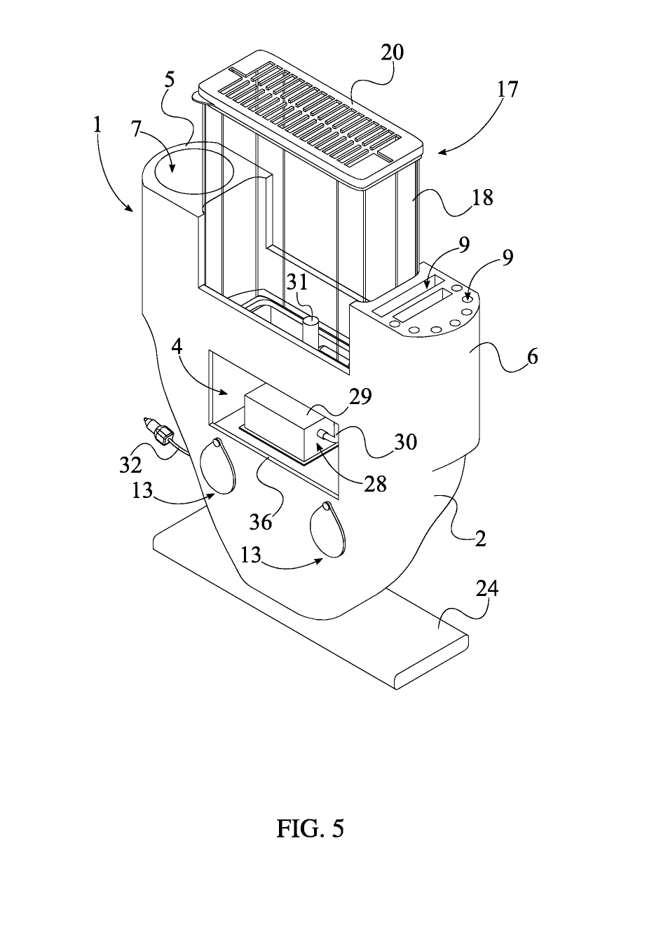

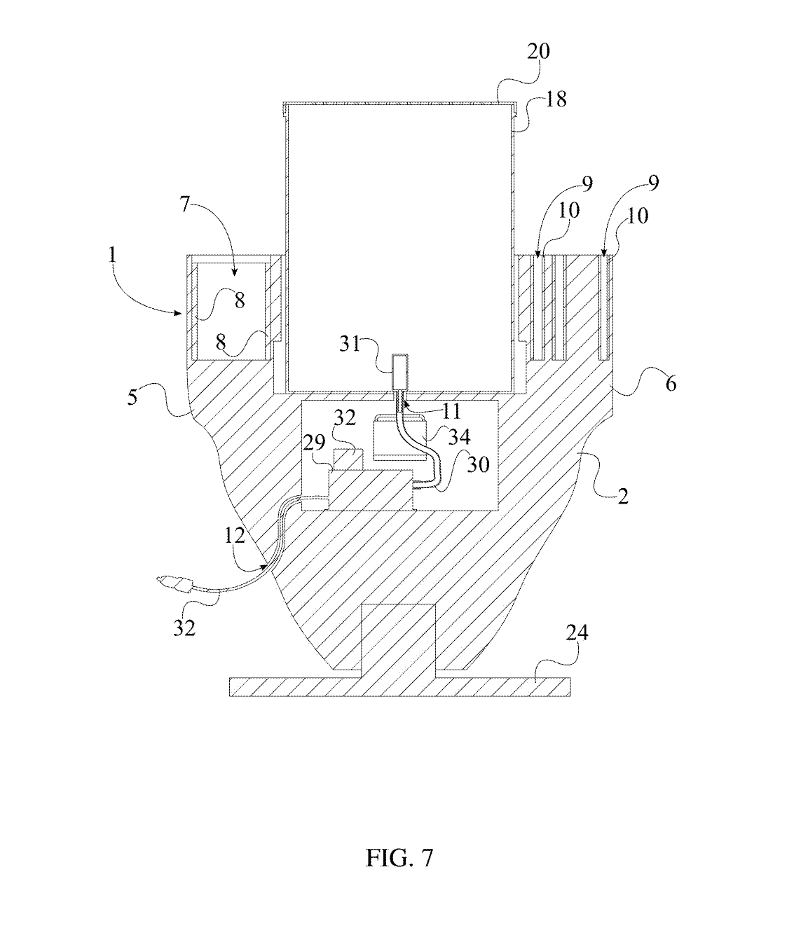

Also in the preferred embodiment, the support structure 1 of the preferred embodiment further comprises first shelf 5 and a second shelf 6, as shown in FIG. 1, FIG. 2, FIG. 4, FIG. 5, and FIG. 7. The first shelf 5 and the second shelf 6 both uphold and organize fishing tools and a variety of items that may be needed by the user while fishing.

The first shelf 5 is connected adjacent to the structure body 2, and the second shelf 6 is connected adjacent to the structure body 2, opposite to the first shelf 5. This configuration allows the receptacle 18 to be removed from the reservoir bed 3 as the reservoir bed 3 is positioned in between the first shelf 5 and the second shelf 6. This configuration also allows the user to easily access the items stored on the first shelf 5 and the second shelf 6.

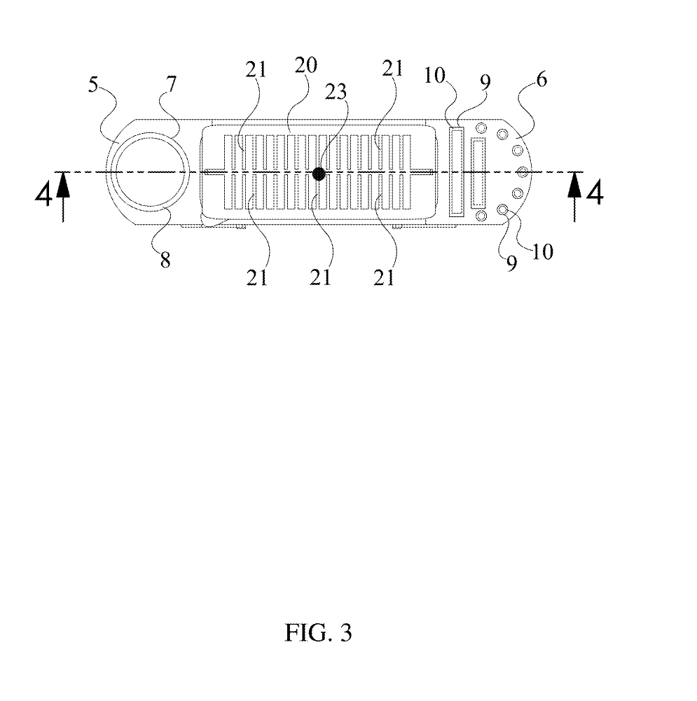

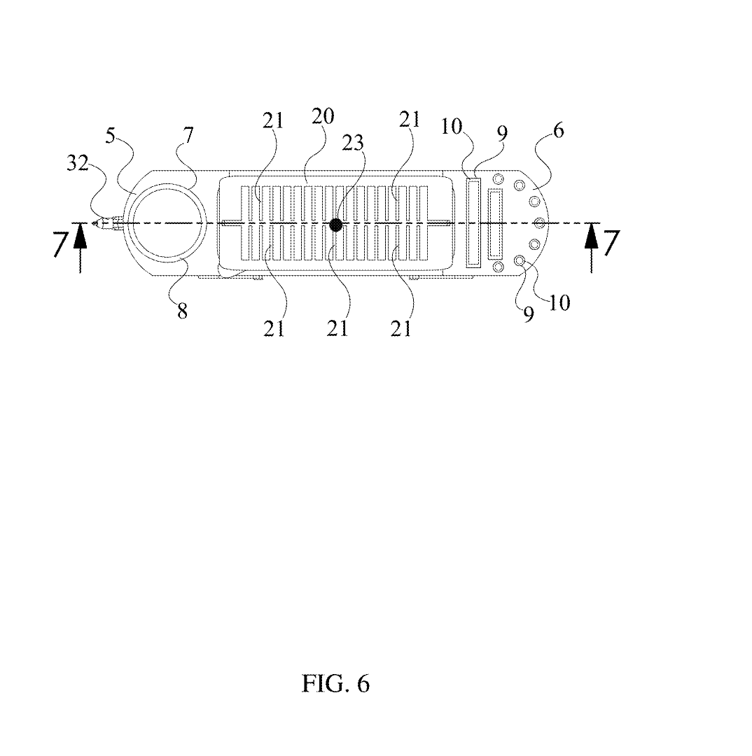

The support structure 1 further comprises a cup holder 7 and a gripping sleeve 8, as shown in FIG. 4 and FIG. 7. In addition, the cup holder 7 houses a bottled or canned beverage or similarly shaped item. The gripping sleeve 8 increases the friction between the bottled or canned beverage and the cup holder 7. The cup holder 7 is integrated into the first shelf 5, and the gripping sleeve 8 is concentrically positioned within the cup holder 7 so that the user may easily insert and remove the beverage from the first shelf 5. The bottled or canned beverage is not able to escape the cup holder 7 unless purposefully removed by the user. Moreover, the support structure 1 further comprises a plurality of accessory cavities 9 and a plurality of elastically deformable sleeves 10, as shown in FIG. 4 and FIG. 7. Similar to the cup holder 7 and the gripping sleeve 8, the plurality of accessory cavities 9 is integrated into the second shelf 6, and each of the plurality of elastically deformable sleeves 10 is concentrically positioned within a corresponding cavity from the plurality of accessory cavities 9. This allows a user to store a variety of fishing tools such as knives, pliers, and hooks within the second shelf 6 and prevents the unwanted removal of the fishing tools unless purposefully removed by the user. As shown in FIG. 3 and FIG. 6, each of the plurality of accessory cavities 9 have varying shapes in order to accommodate specific tools. The accessory cavities 9 with a rectangular shape best houses knives and pliers, and the accessory cavities 9 with a circular shape best houses hooks, jigheads, and lures.

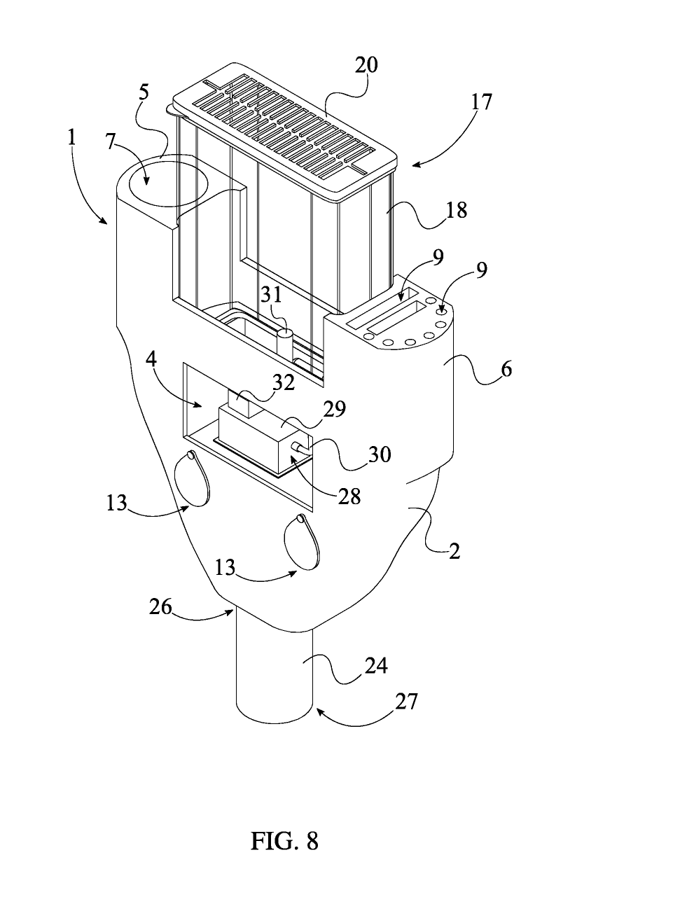

In the preferred embodiment, water retained within the receptacle 18 is properly aerated as the aeration unit 28 of the present invention comprises an air pump 29, a tubing 30, a diffuser 31, and a power source 32, as illustrated in FIG. 1, FIG. 2, FIG. 5, and FIG. 8. Oxygen is pumped out of the air pump 29 and is then delivered to the diffuser 31 via the tubing 30. The diffuser 31 releases oxygen into the water. The power source 32 delivers the necessary power to the air pump 29. In order for the oxygen to be distributed to the water, the diffuser 31 is mounted within the receptacle 18, and the air pump 29 and the diffuser 31 are in fluid communication through the tubing 30. The air pump 29 is situated within the storage compartment 4 so that the oxygen does not need to travel a long distance from the air pump 29 to the diffuser 31. contained within the structure body 2 and is near the receptacle 18, the air pump 29 is situated within the storage compartment 4. The air pump 29 is electrically connected to the power source 32 so that the air pump 29 may constantly generate the oxygen.

In the preferred embodiment of the present invention, the support structure 1 further comprises a first channel 11, which accommodates the shortest path of the tubing 30 from the air pump 29 to the diffuser 31. More specifically, the first channel 11 traverses through the structure body 2 from the storage compartment 4 to the reservoir bed 3, and the tubing 30 is positioned within the first channel 11, as shown in FIG. 4 and FIG. 7. In an embodiment of the present invention, the power source 32 is a portable power source, and the power source 32 is situated within the storage compartment 4. The power source 32 is clearly shown as a portable power source in FIG. 4. The portable power source may be a variety of batteries such as D-cell batteries. In another embodiment of the present invention, the power source 32 is a power cord, as illustrated in FIG. 7. Consequently, the support structure 1 of this embodiment comprises a second channel 12, which is illustrated in FIG. 7. The power cord connects the air pump 29 to an external power source 32 which may be a portable battery or an outlet of the boat. The power cord 29 connects to a portable battery or an outlet of a boat via a plug similar to that illustrated in FIG. 5. In an embodiment of the present invention, the aeration unit 28 may be powered by both the portable power source and the power cord. If either power source 32 fails or runs out of power, the user may provide power to the remaining power source 32. The second channel 12 traverses out of the structure body 2 from the storage compartment 4, and the power cord is positioned through the second channel 12, accommodating the shortest path of the power cord from within the storage compartment 4 to the external power source 32.

In the preferred embodiment of the present invention, the hand-permeable cover 20 comprises a plurality of flexible tabs 21 and a rim 22, as shown in FIG. 3 and FIG. 6. The plurality of flexible tabs 21 prevents the live bait within the receptacle 18 form escaping from the opening 19 of the receptacle 18 while allowing a user's hand to traverse through the hand-permeable cover 20. The rim 22 positions the plurality of flexible tabs 21 about the around the opening 19 of the receptacle 18 and attaches the hand-permeable cover 20 to the receptacle 18. The plurality of flexible tabs 21 is perimetrically distributed about the rim 22 so that the plurality of flexible tabs 21 is spread over the entire opening 19. Each of the plurality of flexible tabs 21 is fixed to the rim 22 and is oriented towards the center 23 of the rim 22, thereby facilitating the passage of the user's hand through the hand-permeable cover 20. The rim 22 is detachably attached to the receptacle 18 about the opening 19, allowing the receptacle 18 to be refilled with both water and live bait. In an alternate embodiment of the present invention, the plurality of flexible tabs 21 that are opposite each other along the perimeter of the rim 22 are connected, thereby defining a plurality of cords that traverse across the hand-permeable cover 20. The plurality of cords provides a more secure hand-permeable cover 20 for live bait that may be more difficult to contain or for a more challenging environment that may facilitate the escape of the live bait.

In order to stabilize the present invention onto the bow rail of a boat, the mounting base 24 is a rigid tube in an embodiment of the present invention. The rigid tube surrounds a post of the bow rail. More specifically, the first end 26 of the rigid tube is positioned adjacent to the structure body 2, and a second end 27 of the rigid tube is oriented away from the water reservoir 17, as shown in FIG. 8. In another embodiment of the present invention, the mounting base 24 is a platform, illustrated in FIG. 1, FIG. 2,

FIG. 4, FIG. 5, and FIG. 7. The platform rests on top of a flat surface of the bow rail and may be secured by a variety of fasteners. The platform is arranged with the structure body 2 such that the structure body 2 is tangentially positioned with the platform. This arrangement orients the structure body 2 in an upright position with respect to the flat surface of the bow rail. In the preferred embodiment of the present invention, the platform comprises a insertable protrusion that vertically traverses into the structure body 2. The insertable protrusion frictionally engages with a slot of the structure body 2 so that the structure body 2 is fastened onto the post of the platform. This engagement prevents the present invention from dismounting while traveling.

In the preferred embodiment of the present invention, the support structure 1 further comprises at least one spare battery compartment 13, as shown in FIG. 1, FIG. 5, and FIG. 8. The at least one spare battery compartment 13 allows a user to store a battery within the structure body 2 in the event the power source 32 fails to power the air pump 29. The battery compartment 13 comprises a battery-receiving cavity 14 and a swivel door 16, as shown in FIG. 2. The battery-receiving cavity 14 positions the battery within the structure body 2, and the swivel door 16 prevents the unwanted escape and damage of the battery within the battery-receiving cavity 14. In order to prevent the unwanted movement of the battery within the structure body 2, the battery-receiving cavity 14 traverses into the structure body 2. The swivel door 16 is pivotally connected to the structure body 2, adjacent to an opening 15 of the battery-receiving cavity so that the user can readily open or close the swivel door 16 in order to access the battery-receiving cavity 14.

Although the invention has been explained in relation to its preferred embodiment, it is to be understood that many other possible modifications and variations can be made without departing from the spirit and scope of the invention as hereinafter claimed.

What is claimed is:

1. A mountable fishing baitwell comprises:
a support structure;
a water reservoir;
a mounting base;
an aeration unit;
the support structure comprises a structure body, a reservoir bed, and a storage compartment;
the water reservoir comprises a receptacle and a hand-permeable cover;
the mounting base being connected adjacent to the structure body;
the reservoir bed being integrated into the structure body, opposite to the mounting base;
the storage compartment being integrated into the structure body in between the reservoir bed and the mounting base;
the receptacle being situated within the reservoir bed;
the hand-permeable cover being detachably attached about an opening of the receptacle;
the aeration unit being mounted within the storage compartment; and
the aeration unit being in fluid communication with the receptacle.

2. The mountable fishing baitwell as claimed as claim 1 comprises:
a light source;
the receptacle and the reservoir bed being made of a transparent material;
the light source being positioned within the storage compartment; and
the light source being oriented towards the receptacle.

3. The mountable fishing baitwell as claimed as claim 1 comprises:
the support structure further comprises a first shelf and a second shelf;
the first shelf being connected adjacent to the structure body;
the second shelf being connected adjacent to the structure body, opposite to the first shelf; and
the reservoir bed being positioned in between the first shelf and the second shelf.

4. The mountable fishing baitwell as claimed as claim 3 comprises:
the support structure further comprises a cup holder and a gripping sleeve;
the cup holder being integrated into the first shelf; and
the gripping sleeve being concentrically positioned within the cup holder.

5. The mountable fishing baitwell as claimed as claim 3 comprises:
the support structure further comprises a plurality of accessory cavities and a plurality of elastically deformable sleeves;
the plurality of accessory cavities being integrated into the second shelf; and
each of the plurality of elastically deformable sleeves being concentrically positioned within a corresponding cavity from the plurality of accessory cavities.

6. The mountable fishing baitwell as claimed as claim 1 comprises:
the aeration unit comprises an air pump, a tubing, a diffuser, and a power source;
the diffuser being mounted within the receptacle;
the air pump being situated within the storage compartment;
the air pump and the diffuser being fluid communication through the tubing; and
the air pump being electrically connected to the power source.

7. The mountable fishing baitwell as claimed as claim 1 comprises:
the support structure further comprises a first channel;
the first channel traversing through the structure body from the storage compartment to the reservoir bed; and
the tubing being positioned within the first channel.

8. The mountable fishing baitwell as claimed as claim 7 comprises:
the power source being a portable power source; and
the portable power source being situated within the storage compartment.

9. The mountable fishing baitwell as claimed as claim 7 comprises:
the support structure further comprises a second channel;
the power source being a power cord;
the second channel traversing out of the structure body from the storage compartment; and
the power cord being positioned through the second channel.

10. The mountable fishing baitwell as claimed as claim 1 comprises:
the hand-permeable cover comprises a plurality of flexible tabs and a rim;
the plurality of flexible tabs being perimetrically distributed about the rim;
each of the plurality of flexible tabs being fixed to the rim;
each of the plurality of flexible tabs being oriented towards a center of the rim; and
the rim being detachably attached to the receptacle about the opening.

11. The mountable fishing baitwell as claimed as claim 1 comprises:
the mounting base being a rigid tube;
a first end of the rigid tube being positioned adjacent to the structure body; and
a second end of the rigid tube being oriented away from the water reservoir.

12. The mountable fishing baitwell as claimed as claim 1 comprises:
the mount being a platform; and
the structure body being tangentially positioned with the platform.

13. The mountable fishing baitwell as claimed as claim 1 comprises:
the support structure further comprises at least one spare battery compartment;
the battery compartment comprises a battery-receiving cavity and a swivel door;
the battery-receiving cavity traversing into the structure body; and
the swivel door being pivotally connected to the structure body, adjacent to an opening of the battery-receiving cavity.

14. The mountable fishing baitwell as claimed as claim 1 comprises:
the structure body further comprises a lip;
the lip traverses along an outer edge of the storage compartment;
